(19) United States
(12) Patent Application Publication
(10) Pub. No.: US 2022/0110332 A1
(43) Pub. Date: Apr. 14, 2022

(54) Natural Component Tick Repellent

(71) Applicant: Organtick LLC, East Stroudsburg, PA (US)

(72) Inventor: Nicole Chinnici, Stroudsburg, PA (US)

(73) Assignee: Organtick LLC, East Stroudsburg, PA (US)

(21) Appl. No.: 17/497,117

(22) Filed: Oct. 8, 2021

Related U.S. Application Data
(60) Provisional application No. 63/090,196, filed on Oct. 10, 2020.

(51) Int. Cl. A01N 65/06; A01N 27/00; A01N 31/04; A01N 31/02; A01P 17/00

(52) U.S. Cl. CPC A01N 65/06; A01N 27/00; A01P 17/00; A01N 31/02; A01N 31/04

(57) ABSTRACT

A natural repellent is based upon the use of pine oil as the sole active ingredient, in combination with inert ingredients (such as denatured ethanol or ethyl alcohol) and a proper conveying medium. The pine oil may take the form of a refined oil of pine, aromatic compounds thereof, or any derivative or monoterpene compound thereof. In particular, the repellent is based upon the use of 0.01-50% refined pine oil (by volume) and is particularly well-suited for use as a tick repellent, as well as for controlling the presence of other biting/non-biting insects and arachnids.

### CROSS-REFERENCE TO RELATED APPLICATIONS

This application claims the benefit of priority of U.S. Provisional Application No. 63/090,196, filed Oct. 10, 2020 and hereby incorporated by reference.

### BACKGROUND OF THE INVENTION

In the United States, Lyme disease is one of the fastest growing vector-borne infectious disease with hundreds of thousands of new cases reported annually. Endemic regions of Lyme disease, i.e., areas with high infection rates, are widely spread throughout the northeast, mid-Atlantic, north central and Midwest. In 2018, the Centers for Disease Control and Prevention (CDC) reported a total of 33,666 confirmed and probable cases of Lyme disease. Among these cases, 33 percent occurred in Pennsylvania. Pennsylvania has ranked number one nationally in reported cases since 2011. In addition to Lyme disease, there are many other tick-borne diseases (TBDs), including Anaplasmosis, Babesiosis, Powassan virus, Tick-borne relapsing fever, Rocky Mountain Spotted fever and Ehrlichiosis. These diseases can be classified as bacterial, viral, or protozoan infections. Diverse in their vectors, geographic distribution and clinical manifestations, TBDs represent a substantial public health crisis in the U.S.

Current tick repellents on the market lack effectiveness and provide a false sense of security to consumers. With limited (to no) regulations on using natural essential oils and plant derived components, various companies have tapped into the insect repellent market offering a variety of “natural” solutions that are essentially ineffective. The current chemical solutions such as DEET were designed by the U.S. military in 1957 specifically to repel mosquitoes.

Biologically, mosquitoes and ticks detect hosts differently. A mosquito flies around and relies on detection of odors, CO₂ and, more importantly, vibrations to hone in on. On the other hand, ticks cannot fly or jump, and they do not have eyes to see. A tick finds a host by waiting on blades of grass and shrubs; sticking out their forelegs to rely on sensing heat, pheromones and CO₂ of passing mammals, birds and reptiles.

To date, there is a lack of research and outdated testing protocols for tick repellents in the scientific literature and through third party testing facilities.

### SUMMARY OF THE INVENTION

The needs remaining in the art are addressed by the present invention, which relates to a natural repellent based upon the use of pine oil as the sole active ingredient (in combination with inert ingredients such as denatured ethanol or ethyl alcohol). The pine oil may take the form of a refined oil of pine, aromatic compounds thereof, or any derivative or monoterpene compound thereof.

The inventive natural repellent comprises 0.01-50% refined pine oil (by volume), with the remainder comprising various inert ingredients (including those defined above), as well as a conveying medium to provide the natural repellent in various product forms (e.g., sprays, lotions, waxes, clothing treatments, and the like). In particular, the refined pine oil may comprise a terpineol multi-constituent, such as a mixture of p-methanols, for example, 2-(4-methyl-1-cyclohex-3-enyl) propan-2-ol.

In an embodiment, the natural repellent of the present invention may be defined as an insect repellent, comprising an active ingredient consisting of 0.01-50% by weight refined pine oil (including all derivatives and monoterpene compounds thereof), a conveying medium for effective transport of the active ingredient, and an inert ingredient selected from the group consisting of denatured ethanol and ethyl alcohol.

Other and further embodiments and aspects of the present invention will become apparent during the course of the following discussion and by reference to the accompanying drawings.

### BRIEF DESCRIPTION OF THE DRAWINGS

Referring now to the drawings:

FIG. 1 is a photographic reproduction of a vertical test strip, used to analyze repellent efficacy, in this case the strip formed of a denim material;

FIG. 2 is a photographic reproduction of an alternative type of vertical test strip that may also be used to analyze repellent efficacy, in this case formed of a conventional Whatman No. 4 filter paper;

FIG. 3 is a block diagram indicating the zones delineated on an exemplary vertical test strip as used to analyze the efficacy of a repellent under test;

FIG. 4 is a table describing an exemplary weighted scoring tool that may be used in the efficacy assessment;

FIG. 5 includes exemplary test results for evaluating several repellent products, including the pine oil-based natural repellent of the present invention;

FIG. 6 is a graph plotting the averaged weighted scores for the products tested in association with the results of FIG. 5;

FIG. 7 shows exemplary test results for evaluating several active ingredients of like concentration, including the pine oil-based active ingredient included in the inventive natural repellent; and

FIG. 8 is a graph plotting the averaged weighted scores for the active ingredients tested in association with the results of FIG. 7.

### DETAILED DESCRIPTION

As mentioned above, ticks are attracted to the scent of pheromones, CO₂ and sources heat in their environment. Ticks lack the ability to see, fly or jump and thus they rely solely on their Haller's organ for sensing. Therefore, the best prevention method to avoid a tickborne illness is to prevent a tick bite from occurring in the first instance. Currently, the insect repellent industry focuses testing on mosquitoes, as mentioned above, which provides false sense of security to American's using these all-purpose insect repellents to prevent the bite of a tick.

An aspect of the present invention addresses this concern by evaluating the repellency of the novel pine oil-based natural repellent formula to two well-known natural repellent suppliers' products, as well as one commonly-used chemical repellent currently on the market. The evaluation also includes an analysis of the active ingredients of other natural repellents and test them against the inventive formula. The latter allows for a direct comparison of the ability of these active ingredients to repel ticks by utilizing an identical concentration as the novel repellent. Methods for testing repellency were based on previous vertical test strip publications, with additions to using various material and a new scoring system. These additions were made to better simulate environmental conditions for ticks.

One issue with current efficiency testing is third party testing laboratories use the Whatman No. 4 filter paper for all testing. When companies do not have the means to conduct their own efficiency testing, they send their product to these third-party facilities for validation. Additionally, these third-party labs may not use the correct tick species for their testing methods. For example, one supplier sends their product to be tested by a third-party laboratory that uses the Brown dog tick to determine the products' efficacy. However, Brown dog ticks, unlike the blacklegged (deer) tick, tend to only feed on one host such as a dog and can live their entire life cycle indoors. These Brown dog ticks do not undergo the characteristic questing behavior that ticks which feed on humans do. Thus, testing with these ticks is not considered to provide a very accurate depiction of repellency.

Details of the Novel Repellent and Testing Protocol

### Novel Repellent

The active ingredient of the novel repellent includes 0.1%-50% (by volume) of pine oil, or a refined oil of pine or derivatives or monoterpene compounds thereof. In particular, the refined pine oil may comprise a terpineol multi-constituent, such as a mixture of p-methanols 2-(4-methyl-1-cyclohex-3-enyl)propan-2-ol.

Also included in the repellent is one or more inert ingredients consisting of a denatured ethanol or ethyl alcohol of 190 or 200 proof. Particular types of such inert ingredients include, but are not limited to, acetaldehyde (SDA 29), acetone (SDA 23-A, 23-H), acetaldol (CDA 18), alkylate (CDA 20), almond oil/butter (SDA 38-B), alpha terpineol (SDA 38-B), aqueous ammonia (SDA 36), strong ammonia solution (SDA 36), anethole, NF (SDA 38-B), anise oil, NF (SDA 38-B), bay/mycia oil, NFXI (SDA 38-B, 39-D), benzaldehyde, NF (SDA 38-B), and tert-butyl alcohol (SDA 39-B, 10, 10-A, 40-B, 40-C).

In accordance with the present invention, the novel repellent may take the form of a lotion, a spray (including environmentally-friendly sprays), candles, repelling devices, clothing treatments, and the like. An appropriate conveying medium, as understood in the art, is included in the final form of the repellent and is selected based on the particular type of product that is desired to be made.

While initially developed for use as a tick repellent, it is to be understood that the novel pine oil-based natural repellent of the present invention is also effective in repelling fleas, mosquitoes, flies, black flies, gnats, spotted lantern flies, chiggers, ants, wasps, bees, spiders, and in general useful in repelling all biting and non-biting insects and arachnids.

Testing Supplies Ticks

All ticks were purchased from the Oklahoma State University tick rearing laboratory. Only adult blacklegged (deer) ticks were used for testing as they are the most medically important tick species in the United States. The blacklegged tick also undergoes the behavior of questing where the tick will climb to the blades of grass and shrubs, stick out their forelegs where they sense mammals, birds and reptiles. This behavior is important when conducting laboratory testing. For this study, a total of five ticks were used for each vertical strip test (as described below), and ticks were only used once for testing. A total of six vertical test strip experiments were completed for each tested ingredient.

### Vertical Test Strips

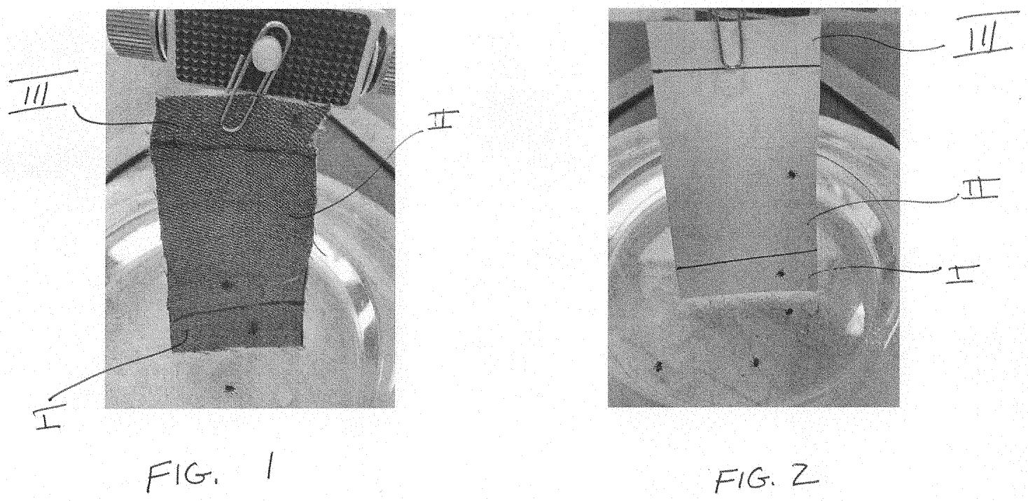

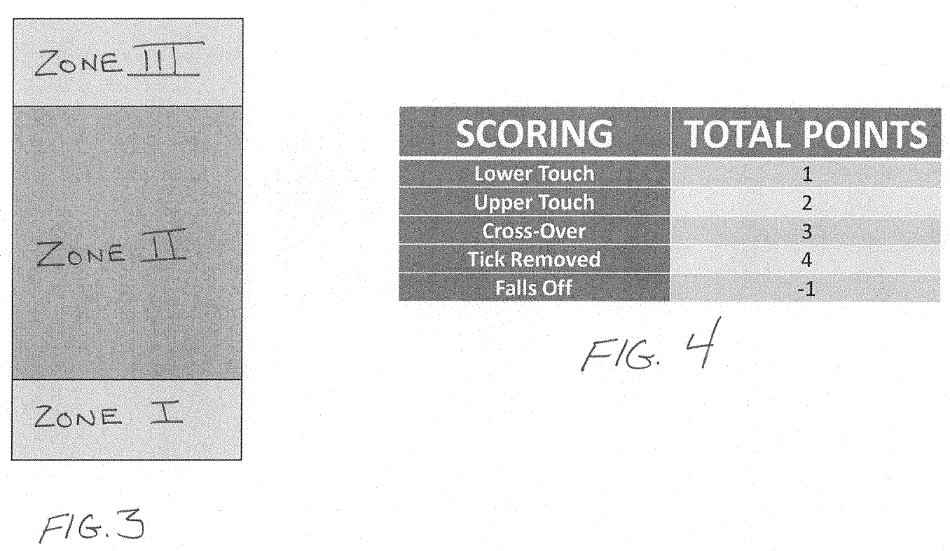

Vertical test strips were made from two materials: (1) denim fabric, which was found to accurately simulate the crawling of ticks onto humans; and (2) Whatman No. 4 filter paper, as used in the prior art for studies of this type. FIG. 1 is photographic reproduction of a vertical test strip formed of denim fabric and FIG. 2 is a photographic reproduction of a vertical test strip formed of Whatman No. 4 filter paper.

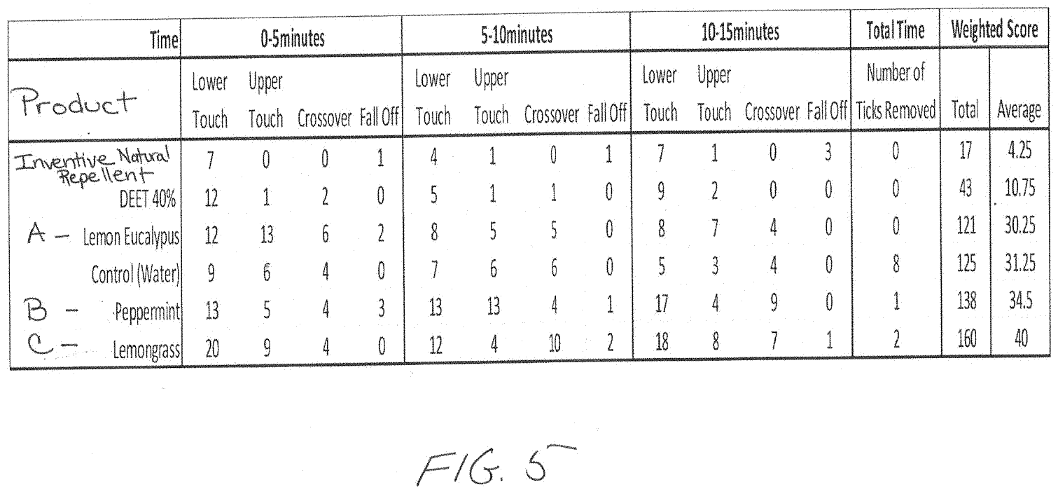

In both cases, the vertical strip test takes advantage of the tendency for ticks to want to crawl up vertically onto a host from their questing position. Test strips were 4×7 cm rectangles which were marked to define three zones, as shown in FIG. 3. The bottom and top zones of the vertical test strip (denoted as “Zone I” and “Zone III”, respectively) were 1×4-cm untreated zones and the middle 4×5-cm zone (“Zone II”) was treated with the repellent product being studied. It is to be understood that vertical test strips of any suitable dimensions may be used; the values indicated above are exemplary only.

### Testing Protocol—Scoring

A scoring system was developed to enable a side-by-side comparison of the inventive natural repellent against other supplier's products (as well as a control). An additional side-by-side comparison of the active ingredient (of like concentration) of each tested product was also made so as to provide a true evaluation of the efficiency of each active ingredient in repelling the ticks.

The scoring system was based on the progress of each tick under study as it traveled upward out of the base Petri dish and onto the vertical strip testing material. In this particular, and with respect to FIG. 3, a “lower touch” where the tick remained on lower, untreated Zone I of the test strip (or at least crawled toward and touched the test strip) was scored as one point. Ticks that touched treated Zone II were scored as two points, and ticks that completely crossed over from lower, untreated Zone I and into treated Zone II were scored as three points. Lastly, any ticks that crossed over treated Zone II and entered upper, untreated Zone III were scored as 4 points (and thereafter removed from testing to avoid the tick from skewing further testing results). A score of “minus one” was recorded for any instance where a tick fell of the test strip, since this indicates a positive reaction to the repellent under study. FIG. 4 contains a table summarizing this weighted scoring structure.

A set of test runs consisted for performing two separate tests using each kind of vertical strip material. The averaged result from a set of test runs was then used to determine the success of a given repellent (or a given active ingredient). Repellents or active ingredients with low scores, no cross-overs, and falls may be classified as effectively repelling ticks, where high-valued scores are considered to be indicative of a weak repellent. Indeed, any product (or active ingredient) with a score higher than recorded for the control (e.g., “water”) was considered as an attractant, and not a repellent.

### Testing Protocol—Procedure

Throughout a fifteen minute testing interval, a technician would record results on tick movements, using the weighted scoring system outlined above. Ticks were considered repelled if they remained within the petri dish avoiding the treated vertical test strip. Additional notes were recorded for location of ticks during 1, 3, 5, 10 and 15-minutes. If a tick climbed to the edge of the petri dish, it was removed and placed back in the middle of the Petri dish in the region of untreated zone I.

Testing Results

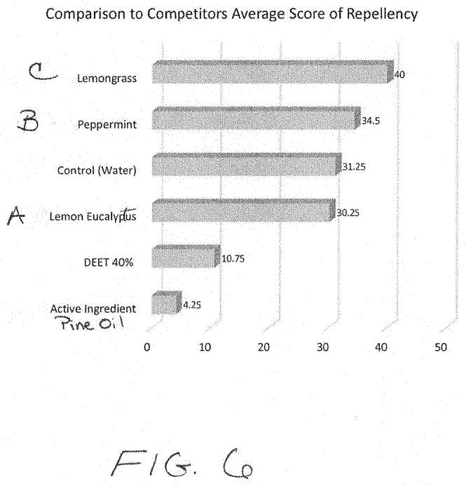

FIG. 5 is a table of test results associated with performing a side-by-side testing of the inventive pine oil-based repellent against three different, commercially-available natural products (denoted as products A, B, and C in FIG. 5), as well as the standard DEET formula. As a control, a set of tests were performed where zone II of the vertical test strip was treated only with water. The results as shown in FIG. 5 were tabulated based on the weighted score, using the system as described above. Both the cumulative weighted score and its associated average value are shown in FIG. 5. These results clearly show that at least two commercially-available natural products are more of an attractant than a repellent. The inventive pine oil-based natural repellent is shown to have scored better than even the DEET product.

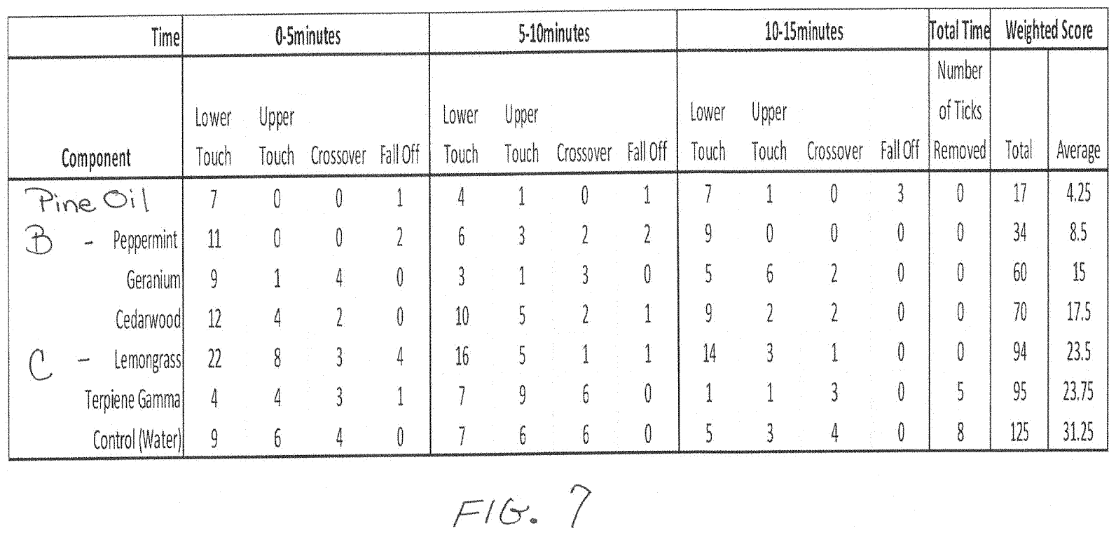

FIG. 6 summarizes the data from FIG. 5 in graphical form, in this case plotting the averaged score repellency. As described above, the lower the score, the higher the efficacy of the repellent. Higher scores that are close to the average of the control may be considered as “neutral”, with scores much greater than neutral more likely to be associated with an attractant, rather than a repellant. Again, the inventive repellent is shown to have a much lower averaged score than any of the other products.

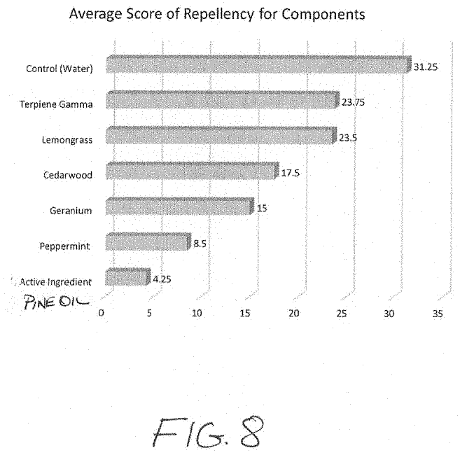

FIG. 7 is a table similar in form to that of FIG. 5, but in this case is associated with testing several different active ingredients (some as found in the products mentioned above), in each case using the same concentration of active ingredient on treated zone II of the vertical test strip. All tests were completed at the same concentration, with the same species of tick and at the same time of the day to limit confounding variables. Again, the pine oil, used as the active ingredient in the inventive natural tick repellent, scored significantly better (i.e., lower) than the other active ingredients. Both the total weighted score and the averaged weighted score results of the inventive repellent out-ranked the others. FIG. 8 is a plot (similar to that of FIG. 6).

### Conclusion

When comparing the novel repellent's active ingredient to DEET, the most common chemical insect repellent, the active ingredient worked 50% better on average. Throughout testing, the active ingredient within the novel repellent was the best performing repellent against blacklegged ticks. The blacklegged tick is the most medically relevant tick for transmitting Lyme disease, Anaplasmosis and Babesiosis to humans and pets. From unpublished research from the East Stroudsburg University tick lab, 80% of tick bites are from the blacklegged tick. This analysis illustrates the effectiveness of the novel repellent to repel ticks using a modified testing protocol to simulate the accurate behavior of ticks in the environment as well as using the most common tick causing illness in humans and pets.

There have been described herein natural repellents which incorporate refined pine oil (in some form) as the sole active ingredient into a conveying medium. While particular embodiments have been described, it is not intended that the invention be limited thereto, as it is intended that the invention be as broad in scope as the art will allow. Thus, while preferred percentages and ranges of pine oil have been described, it will be appreciated that different percentages may be utilized, which may nonetheless modify the efficacy of the natural repellent. Further while preferred conveying mediums have been described, other mediums including, but not limited to, lotions, sprays, and creams could be utilized. Therefore, it will be appreciated by those skilled in the art that yet other modifications could be made to the provided invention without deviating from its spirit and scope as so claimed.

What is claimed is:

1. An insect repellent, comprising
an active ingredient consisting of 0.01-50% by weight refined pine oil, including all derivatives and monoterpene compounds thereof;
a conveying medium for effective transport of the active ingredient; and
an inert ingredient selected from the group consisting of denatured ethanol and ethyl alcohol.

2. The insect repellent as defined in claim 1 wherein the refined pine oil comprises a terpineol multi-constituent.

3. The insect repellent as defined in claim 2 wherein the terpineol multi-constituent comprises a mixture of p-methanols.

4. The insect repellent as defined in claim 3, comprising 2-(4-methyl-1-cyclohex-3-enyl)propan-2-ol.

5. The insect repellent as defined in claim 1 wherein the inert ingredient is about 190 proof.

6. The insect repellent as defined in claim 1 wherein the inert ingredient is about 200 proof.

7. The insect repellent as defined in claim 1 wherein the conveying medium is a lotion.

8. The insect repellent as defined in claim 1 wherein the conveying medium is a spray.

9. The insect repellent as defined in claim 1 wherein the conveying medium is a wax product.

10. The insect repellent as defined in claim 1 wherein the conveying medium is a liquid for use in treating clothing.

11. The insect repellent as defined in claim 1 wherein the inert ingredient is selected from the group of denatured ethanols and ethyl alcohols consisting of: acetaldehyde (SDA 29), acetone (SDA 23-A, 23-H), acetaldol (CDA 18), alkylate (CDA 20), almond oil/butter (SDA 38-B), alpha terpineol (SDA 38-B), aqueous ammonia (SDA 36), strong ammonia solution (SDA 36), anethole, NF (SDA 38-B), anise oil, NF (SDA 38-B), bay/mycia oil, NFXI (SDA 38-B, 39-D), benzaldehyde, NF (SDA 38-B), and tert-butyl alcohol (SDA 39-B, 10, 10-A, 40-B, 40-C).

12. A tick repellent, comprising
an active ingredient consisting of 0.01-50% by weight refined pine oil, including all derivatives and monoterpene compounds thereof;
a conveying medium for effective transport of the active ingredient; and
an inert ingredient selected from the group consisting of denatured ethanol and ethyl alcohol.

13. The tick repellent as defined in claim 12 wherein the refined pine oil comprises wherein the refined pine oil comprises a terpineol multi-constituent.

14. The tick repellent as defined in claim 13 wherein the terpineol multi-constituent comprises a mixture of p-methanols.

15. The tick repellent of claim 14, comprising 2-(4-methyl-1-cyclohex-3-enyl)propan-2-ol.

16. A natural repellent for use with biting and non-biting insects, and biting and non-biting arachnids, comprising
an active ingredient consisting of 0.01-50% by weight refined pine oil, including all derivatives and monoterpene compounds thereof;
a conveying medium for effective transport of the active ingredient; and
an inert ingredient selected from the group consisting of denatured ethanol and ethyl alcohol.

17. The natural repellent as defined in claim 16 wherein the refined pine oil comprises a terpineol multi-constituent.

18. The natural repellent as defined in claim 17 wherein the terpineol multi-constituent comprises a mixture of p-methanols.

19. The natural repellent of claim 18, wherein the terpineol multi-constituent comprises 2-(4-methyl-1-cyclohex-3-enyl)propan-2-ol.
